(19) United States
(12) Patent Application Publication
(10) Pub. No.: US 2025/0005336 A1
(43) Pub. Date: Jan. 2, 2025

(54) CAUSAL REPRESENTATION LEARNING FOR INSTANTANEOUS TEMPORAL EFFECTS

(71) Applicant: QUALCOMM TECHNOLOGIES, INC., San Diego, CA (US)

(72) Inventors: Phillip LIPPE, Amsterdam (NL); Yuki Markus ASANO, Amsterdam (NL); Sara MAGLIACANE, Amsterdam (NL); Taco Sebastiaan COHEN, Amsterdam (NL); Efstratios GAVVES, Amsterdam (NL)

(21) Appl. No.: 18/710,150

(22) PCT Filed: Jan. 24, 2023
(86) PCT No.: PCT/US2023/011470

§ 371 Date: May 14, 2024

(30) Foreign Application Priority Data
Jan. 27, 2022 (GR) 20220100080
May 19, 2022 (GR) 20220100417

(51) Int. Cl. G06N 3/0475; G06V 10/82

(52) U.S. Cl. CPC G06N 3/0475; G06V 10/82

(57) ABSTRACT

A processor-implemented method for causal representation learning of temporal effects includes receiving, via an artificial neural network (ANN), temporal sequence data for high-dimensional observations. The ANN generates a latent representation based on latent variables for the temporal sequence data. The latent variables of the temporal sequence data are assigned to causal variables. The ANN determines a representation of causal factors for each dimension of the temporal sequence databased on the assignment.

### CROSS-REFERENCE TO RELATED APPLICATION

The present application claims priority to Greece Patent Application No. 20220100080, filed on Jan. 27, 2022, and titled “CASUAL IDENTIFIABILITY FROM TEMPORAL SEQUENCES WITH INTERVENTIONS,” and Greece Patent Application No. 20220100417, filed on May 19, 2022, and titled “CAUSAL REPRESENTATION LEARNING FOR INSTANTANEOUS TEMPORAL EFFECTS,” the disclosures of which are expressly incorporated by reference in their entireties.

### BACKGROUND

### Field

Aspects of the present disclosure generally relate to causal representation learning for instantaneous temporal effects.

### Background

Artificial neural networks may comprise interconnected groups of artificial neurons (e.g., neuron models). The artificial neural network may be a computational device or be represented as a method to be performed by a computational device. Convolutional neural networks (CNNs) are a type of feed-forward artificial neural network. Convolutional neural networks may include collections of neurons that each have a receptive field and that collectively tile an input space. Convolutional neural networks, such as deep convolutional neural networks (DCNs), have numerous applications. In particular, these neural network architectures are used in various technologies, such as image recognition, pattern recognition, speech recognition, autonomous driving, and other classification tasks.

DCNs, such as deep learning models have also been applied to to the task of causal representation learning. Causal representation learning is the task of identifying underlying causal variables and their relations from high-dimensional observations, such as images. Conventional approaches reconstruct the causal variables from temporal sequences of observations under the assumption that there are no instantaneous causal relations between them. In practical applications, however, a measurement or frame rate may be slower than many of the causal effects, effectively producing “instantaneous” effects and thus invalidating previous identifiability results.

### SUMMARY

The present disclosure is set forth in the independent claims, respectively. Some aspects of the disclosure are described in the dependent claims.

In one aspect of the present disclosure, a processor-implemented method includes receiving, via an artificial neural network (ANN), temporal sequence data for high-dimensional observations. The method further includes generating, via the ANN, latent representation based on latent variables for the temporal sequence data. The method still further includes assigning the latent variables of the temporal sequence data to causal variables. The method also includes determining, via the ANN, a representation of causal factors for each dimension of the temporal sequence data based on the assignment.

Another aspect of the present disclosure is directed to an apparatus including means for receiving, via an artificial neural network (ANN), temporal sequence data for high-dimensional observations. The apparatus further includes means for generating, via the ANN, latent representation based on latent variables for the temporal sequence data. The apparatus still further includes means for assigning the latent variables of the temporal sequence data to causal variables. The apparatus also includes means for determining, via the ANN, a representation of causal factors for each dimension of the temporal sequence data based on the assignment.

In another aspect of the present disclosure, a non-transitory computer-readable medium with non-transitory program code recorded thereon is disclosed. The program code is executed by a processor and includes program code to receive, via an artificial neural network (ANN), temporal sequence data for high-dimensional observations. The program code further includes program code to generate, via the ANN, latent representation based on latent variables for the temporal sequence data. The program code still further includes program code to assign the latent variables of the temporal sequence data to causal variables. The program code also includes program code to determine, via the ANN, a representation of causal factors for each dimension of the temporal sequence data based on the assignment.

Another aspect of the present disclosure is directed to an apparatus having a memory and one or more processors coupled to the memory. The processor(s) is configured to receive, via an artificial neural network (ANN), temporal sequence data for high-dimensional observations. The processor(s) is further configured to generate, via the ANN, latent representation based on latent variables for the temporal sequence data. The processor(s) is still further configured to assign the latent variables of the temporal sequence data to causal variables. The processor(s) is also configured to determine, via the ANN, a representation of causal factors for each dimension of the temporal sequence data based on the assignment.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a neural network using a system-on-a-chip (SOC), including a general-purpose processor, in accordance with certain aspects of the present disclosure.

FIGS. 2A, 2B, and 2C are diagrams illustrating a neural network, in accordance with aspects of the present disclosure.

FIG. 2D is a diagram illustrating an exemplary deep convolutional network (DCN), in accordance with aspects of the present disclosure.

FIG. 3 is a block diagram illustrating an exemplary deep convolutional network (DCN), in accordance with aspects of the present disclosure.

FIG. 4 is a block diagram illustrating an exemplary software architecture that may modularize artificial intelligence (AI) functions, in accordance with aspects of the present disclosure.

FIG. 5A is a block diagram illustrating an example architecture for causal representation learning for instantaneous temporal effects, in accordance with aspects of the present disclosure.

FIG. 5B is a block diagram illustrating a target classifier, in accordance with aspects of the present disclosure.

FIG. 6 is a block diagram illustrating an example architecture for causal representation learning, in accordance with aspects of the present disclosure.

FIG. 7A is a block diagram illustrating an example process for causal representation learning, in accordance with aspects of the present disclosure.

FIG. 7B is a block diagram illustrating an example architecture for causal representation learning for instantaneous temporal effects, in accordance with aspects of the present disclosure.

FIG. 8 is a flow diagram illustrating a process for operating an example architecture for identifying causal factors from temporal sequences with interventions, in accordance with aspects of the present disclosure.

FIG. 9 is a flow diagram illustrating an example process for causal representation learning for instantaneous temporal effects using an artificial neural network, in accordance with aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Learning a causal representation of an environment is a task of increasing interest. Causal representation learning may be considered the discovery of high-level causal variables from high-dimensional observations, such as images or videos, for example. The causal factors of an observation are independent given its previous time step. Note that the marginal distributions of the factors can be highly entangled (e.g., combined). In between time steps, interventions may have been performed on the factors. Thus, the samples of the interventions may be independent across variables and may affect single factors. A practical example of this setting is an agent that has multiple actions at hand, where each action only affects a single object in the environment. In addition, the targets of the interventions may have been observed. This means that the variables that have been intervened in between two time steps may be known. However, there may be no information about what these variables actually represent or their respective values.

In conventional approaches, causal variables may be identified from temporal sequences if the variables are conditionally independent based on the previous time step. That is, conventional approaches may assume that within a discrete time step, intervening on one causal factor does not affect any other causal factor. However, in real-world systems, causal factors may causally interact with each other within a time step, which naturally occurs for low-observation frame rates. Accordingly, aspects of the present disclosure are directed to causal representation learning for instantaneous temporal effects.

In accordance with aspects of the present disclosure, causal factors may be identified from temporal observations while simultaneously or concurrently learning a corresponding instantaneous causal graph. In addition, differentiable causal discovery techniques may be integrated in a representation learning framework, while stabilizing an optimization process by enforcing interventional independencies in the latent space. Accordingly, identifiability of multidimensional causal factors and their instantaneous graphs under perfect intervention observations may be achieved.

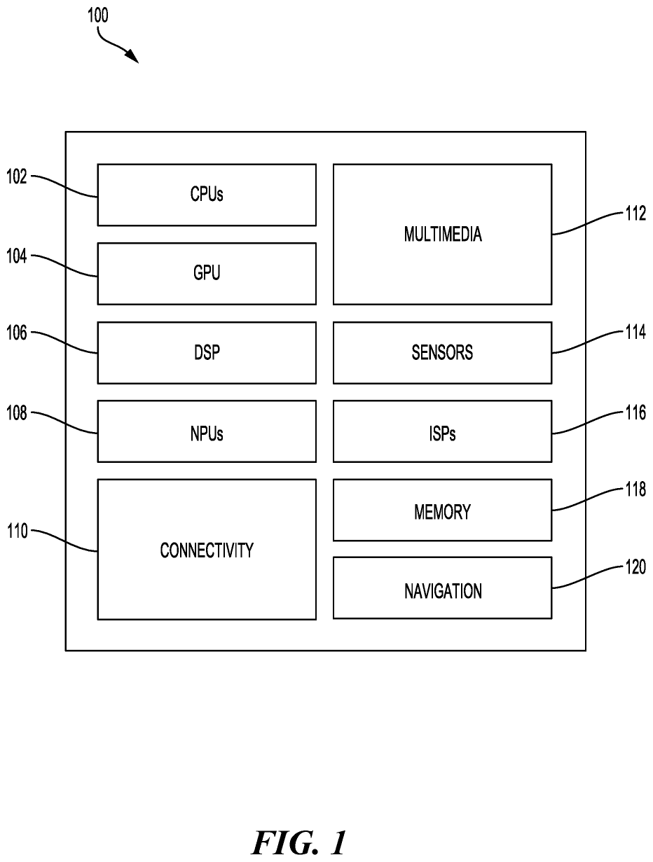

FIG. 1 illustrates an example implementation of a system-on-a-chip (SOC) 100, which may include a central processing unit (CPU) 102 or a multi-core CPU configured for learning causal representations for instantaneous temporal effects. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM instruction set. In an aspect of the present disclosure, the instructions loaded into the general-purpose processor 102 may include code to receive, via the ANN, temporal sequence data for high-dimensional observations. The general-purpose processor 102 may also include code to generate, via the ANN, latent variables for the temporal sequence data. In addition, the general-purpose processor 102 may include code to assign the latent variables of the temporal sequence data to causal variables. The general-purpose processor 102 may further include code to determine, via the ANN, a representation of causal factors for each dimension of the temporal sequence data based on the assignment.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

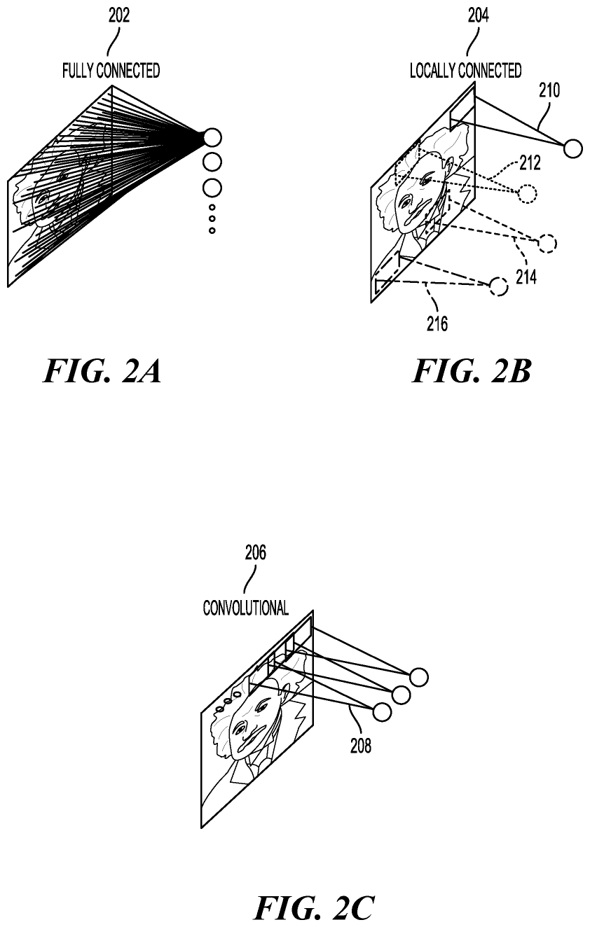

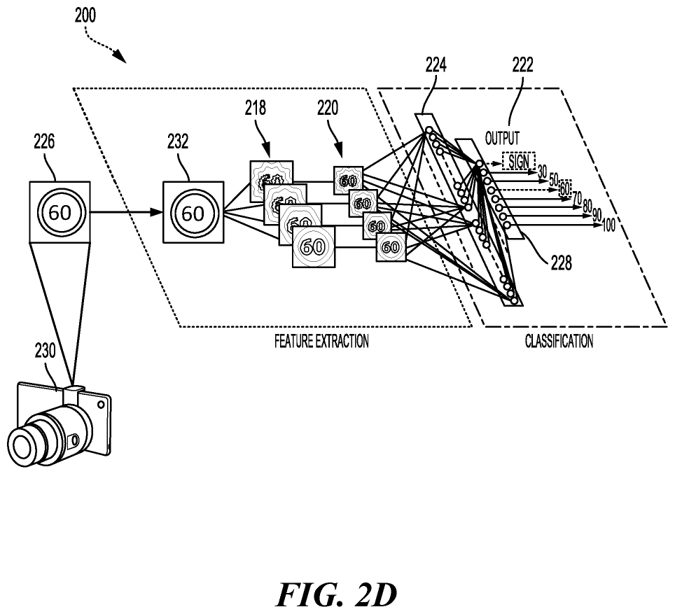

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

One type of convolutional neural network is a deep convolutional network (DCN). FIG. 2D illustrates a detailed example of a DCN 200 designed to recognize visual features from an image 226 input from an image capturing device 230, such as a car-mounted camera. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 is a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 is likely to be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN may be presented with new images and a forward pass through the network may yield an output 222 that may be considered an inference or a prediction of the DCN.

Deep belief networks (DBNs) are probabilistic models comprising multiple layers of hidden nodes. DBNs may be used to extract a hierarchical representation of training datasets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., 220) receiving input from a range of neurons in the previous layer (e.g., feature maps 218) and from each of the multiple channels. The values in the feature map may be further processed with a non-linearity, such as a rectification, max(0, x). Values from adjacent neurons may be further pooled, which corresponds to down sampling, and may provide additional local invariance and dimensionality reduction. Normalization, which corresponds to whitening, may also be applied through lateral inhibition between neurons in the feature map.

The performance of deep learning architectures may increase as more labeled data points become available or as computational power increases. Modem deep neural networks are routinely trained with computing resources that are thousands of times greater than what was available to a typical researcher just fifteen years ago. New architectures and training paradigms may further boost the performance of deep learning. Rectified linear units may reduce a training issue known as vanishing gradients. New training techniques may reduce over-fitting and thus enable larger models to achieve better generalization. Encapsulation techniques may abstract data in a given receptive field and further boost overall performance.

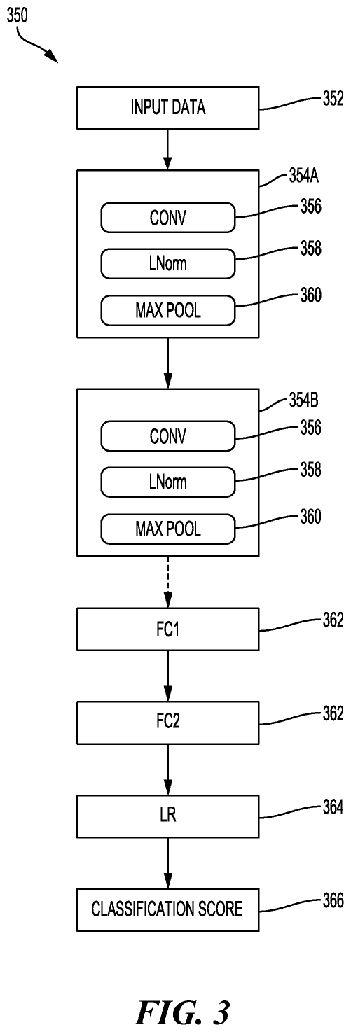

FIG. 3 is a block diagram illustrating a deep convolutional network 350. The deep convolutional network 350 may include multiple different types of layers based on connectivity and weight sharing. As shown in FIG. 3, the deep convolutional network 350 includes the convolution blocks 354A, 354B. Each of the convolution blocks 354A, 354B may be configured with a convolution layer (CONV) 356, a normalization layer (LNorm) 358, and a max pooling layer (MAX POOL) 360.

The convolution layers 356 may include one or more convolutional filters, which may be applied to the input data to generate a feature map. Although only two of the convolution blocks 354A, 354B are shown, the present disclosure is not so limiting, and instead, any number of the convolution blocks 354A, 354B may be included in the deep convolutional network 350 according to design preference. The normalization layer 358 may normalize the output of the convolution filters. For example, the normalization layer 358 may provide whitening or lateral inhibition. The max pooling layer 360 may provide down sampling aggregation over space for local invariance and dimensionality reduction.

The parallel filter banks, for example, of a deep convolutional network may be loaded on a CPU 102 or GPU 104 of an SOC 100 to achieve high performance and low power consumption. In alternative embodiments, the parallel filter banks may be loaded on the DSP 106 or an ISP 116 of an SOC 100. In addition, the deep convolutional network 350 may access other processing blocks that may be present on the SOC 100, such as sensor processor 114 and navigation module 120, dedicated, respectively, to sensors and navigation.

The deep convolutional network 350 may also include one or more fully connected layers 362 (FC1 and FC2). The deep convolutional network 350 may further include a logistic regression (LR) layer 364. Between each layer 356, 358, 360, 362, 364 of the deep convolutional network 350 are weights (not shown) that are to be updated. The output of each of the layers (e.g., 356, 358, 360, 362, 364) may serve as an input of a succeeding one of the layers (e.g., 356, 358, 360, 362, 364) in the deep convolutional network 350 to learn hierarchical feature representations from input data 352 (e.g., images, audio, video, sensor data and/or other input data) supplied at the first of the convolution blocks 354A. The output of the deep convolutional network 350 is a classification score 366 for the input data 352. The classification score 366 may be a set of probabilities, where each probability is the probability of the input data including a feature from a set of features.

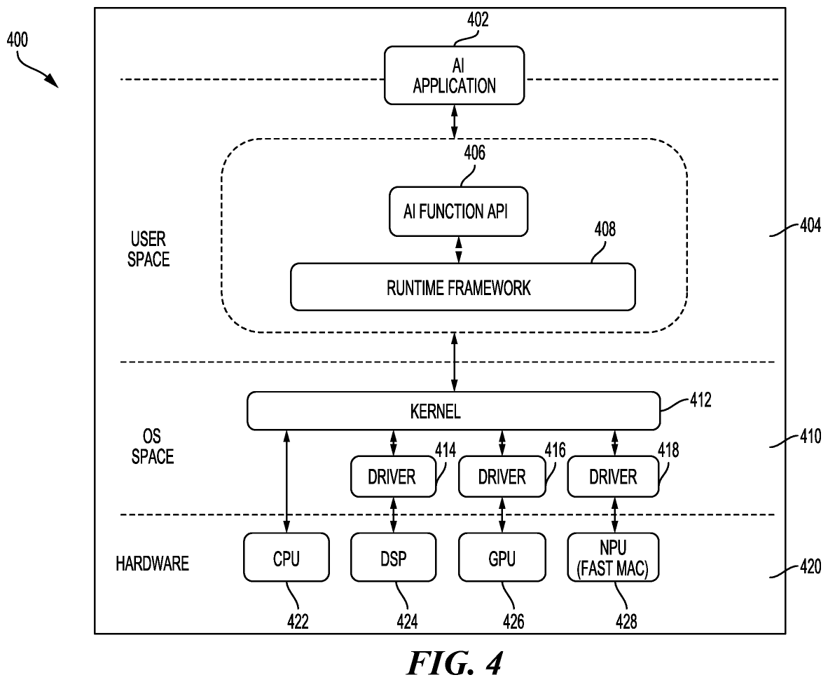

FIG. 4 is a block diagram illustrating an exemplary software architecture 400 that may modularize artificial intelligence (AI) functions. Using the architecture 400, applications may be designed that may cause various processing blocks of an SOC 420 (for example a CPU 422, a DSP 424, a GPU 426 and/or an NPU 428) to support adaptive rounding as disclosed for post-training quantization for an AI application 402, according to aspects of the present disclosure. The architecture 400 may, for example, be included in a computational device, such as a smartphone.

The AI application 402 may be configured to call functions defined in a user space 404 that may, for example, provide for the detection and recognition of a scene indicative of the location at which the computational device including the architecture 400 currently operates. The AI application 402 may, for example, configure a microphone and a camera differently depending on whether the recognized scene is an office, a lecture hall, a restaurant, or an outdoor setting such as a lake. The AI application 402 may make a request to compiled program code associated with a library defined in an AI function application programming interface (API) 406. This request may ultimately rely on the output of a deep neural network configured to provide an inference response based on video and positioning data, for example.

A run-time engine 408, which may be compiled code of a runtime framework, may be further accessible to the AI application 402. The AI application 402 may cause the run-time engine 408, for example, to request an inference at a particular time interval or triggered by an event detected by the user interface of the AI application 402. When caused to provide an inference response, the run-time engine 408 may in turn send a signal to an operating system in an operating system (OS) space 410, such as a Kernel 412, running on the SOC 420. In some examples, the Kernel 412 may be a LINUX Kernel. The operating system, in turn, may cause a continuous relaxation of quantization to be performed on the CPU 422, the DSP 424, the GPU 426, the NPU 428, or some combination thereof. The CPU 422 may be accessed directly by the operating system, and other processing blocks may be accessed through a driver, such as a driver 414, 416, or 418 for, respectively, the DSP 424, the GPU 426, or the NPU 428. In the exemplary example, the deep neural network may be configured to run on a combination of processing blocks, such as the CPU 422, the DSP 424, and the GPU 426, or may be run on the NPU 428.

The AI application 402 may be configured to call functions defined in the user space 404 that may, for example, provide for the detection and recognition of a scene indicative of the location in which the computational device including the architecture 400 currently operates. The application 402 may, for example, configure a microphone and a camera differently depending on whether the recognized scene is an office, a lecture hall, a restaurant, or an outdoor setting such as a lake. The AI application 402 may make a request to compiled program code associated with a library defined in a SceneDetect application programming interface (API) 406 to provide an estimate of the current scene. This request may ultimately rely on the output of a differential neural network configured to provide scene estimates based on video and positioning data, for example.

A run-time engine 408, which may be compiled code of a Runtime Framework, may be further accessible to the application 402. The application 402 may cause the run-time engine 408, for example, to request a scene estimate at a particular time interval or triggered by an event detected by the user interface of the application. When caused to estimate the scene, the run-time engine 408 may in turn send a signal to the operating system 410, such as the Kernel 412, running on the SOC 420. The operating system 410, in turn, may cause a computation to be performed on the CPU 422, the DSP 424, the GPU 426, the NPU 428, or some combination thereof. The CPU 422 may be accessed directly by the operating system, and other processing blocks may be accessed through a driver, such as the driver 414-418 for the DSP 424, for the GPU 426, or for the NPU 428. In the exemplary example, the differential neural network may be configured to run on a combination of processing blocks, such as the CPU 422 and the GPU 426, or may be run on the NPU 428.

Aspects of the present disclosure are directed to causal representation learning for instantaneous temporal effects. In accordance with aspects of the present disclosure, a variational autoencoder framework is presented. The variational autoencoder framework may learn causal representations from temporal sequences of images in which some underlying causal factors may have been intervened upon. In contrast to conventional approaches, aspects of the present disclosure may exploit temporality and information about intervention targets to identify scalar and multidimensional causal factors, such as a position in three-dimensional (3D) space, or 3D rotation angles, for example.

Learning causal representations aims at identifying or discovering the causal factors of various underlying systems from observations such as images. Some conventional approaches have focused on different settings where identifying the causal factors is possible. For instance, some conventional approaches focus on the scenario where the true causal factors are statistically independent. In such approaches, given a set of pairs of images or other high-dimensional data, where only a subset of the causal factors changes between the two data points, then the causal factors can be found. However, it is often not possible to retrieve such data.

In accordance with aspects of the present disclosure, causal factors may be considered as potentially multidimensional vectors. For instance, in the context of an autonomously driving car, the weather may be a causal factor that influences the driving behavior (e.g., the vehicle speed or the driving behavior of other cars). However, the weather is not a scalar factor, because besides general settings like rain, fog, and snow, weather may also have additional dimensions like strength or intensity of the rain, the wind direction and intensity, sunlight, and other dimensions. Although in the real-world, intervening on individual factors of the weather is not possible, individual factors of the weather may be influenced for the car, for example, by changing its route (e.g., by driving into a rain cloud or driving around it) while keeping other causal factors like the car's configuration unchanged. Hence, an intervention can effectively be performed on the weather dimensions together, rather than on individual parts of the weather dimensions. Further, it is difficult to manually design the independent dimensions of the weather's causal factors because the weather itself underlies a complex physical system with a combination of factors, some of which may be irrelevant for the autonomous car. Thus, it may be more beneficial to consider weather as a multidimensional causal factor for which the agent model designs the dimensions optimized for its downstream task of steering the vehicle.

Accordingly, aspects of the present disclosure are directed to identifying or discovering the minimal causal mechanisms, which are the smallest mechanisms per causal factor describing the effects of interventions in the causal space. In doing so, the information of the causal factor, which is dependent on an intervention, may be identified. Such information of the causal factors may be directly influenced by the action of an agent, for example, while information that cannot be assigned to a factor may be collected in a separate group of latent representations. In accordance with aspects of the present disclosure, causal variables and their causal graphs may be identified from temporal sequences, even in the case of potentially instantaneous causal relations.

As a practical implementation, a variational autoencoder framework may be employed to learn an assignment of latent-to-causal factors. In some aspects, disentanglement of causal factors may be promoted by conditioning each latent's prior distribution only on its respective intervention target. Moreover, in some aspects, pre-trained autoencoders may learn a normalizing flow to map the entangled autoencoder representation to a disentangled causal representation. In a restricted setting, the flow may also generalize its disentanglement to unseen instantiations of causal factors.

A directed graph is a tuple G=(V,E), where V is the set of vertices and E⊆V∈V is the set of edges between the vertices. A tuple is a finite ordered list or sequence of elements. A cycle is a sequence of edges i→ . . . →i with at least one directed edge. If a directed graph does not contain any cycles, it is referred to as a directed acyclic graph (DAG).

DAGs may represent causal models, where each vertex i is associated with a random variable Xᵢ. Each random variable may be a scalar or vector valued. Multiple causal variables X₁, . . . , X_{K} may be clustered as a single random variable X=(X₁, . . . , X_{K}), in which case X inherits all incoming and outgoing edges from its components Xᵢ for i=1, . . . , K. A directed edge i→j in a causal DAG G may represent a direct causal relationship of cause Xᵢ on effect Xⱼ. The random variable Xᵢ may be considered a parent of Xᵢ, and the set of parents of Xᵢ may be denoted as pa(Xᵢ). A distribution p^{obs} is Markov with respect to a DAG G if the distribution p^{obs} factors as p^{obs}(X)=Π_{i∈V}p^{obs}(Xᵢ|pa(Xᵢ)).

A binary intervention vector l∈{0,1}^{K}, where K is the number of vertices in G, may indicate that a variable Xᵢ in G is intervened upon if and only if Iᵢ=1, for example. Each intervention vector component Iᵢ may be considered as a causal variable, and specifically, a parent of the associated Xᵢ in an augmented graph G′=(V∪{Iᵢ}K, E∪{Iᵢ→Xᵢ}ᵢ₌₁^{K}). Given the intervention vector I, the distributions (p^{obs}, P^{I}) are I-Markov to G if p^{obs} is Markov to G and p^{I} factors as follows:

$${p}^{I} ( X ) = {\prod }_{i} p ( {X}_{i} \vert pa ( {X}_{i} ) , {I}_{i} )$$

$$p ( {X}_{i} \vert pa ( {X}_{i} ) , {I}_{i} ) = \{ \begin{matrix}{p}^{obs} ( {X}_{i} \vert pa ( {X}_{i} ) ) , & if {I}_{i} = 0 \\ {p}^{I} ( {X}_{i} \vert pa ( {X}_{i} ) ) , & if {I}_{i} = 1\end{matrix}$$

In this setup, interventions may be modeled with an arbitrary number of targets, including trivially the empty set (e.g., observational data). In some aspects, the setup may model perfect interventions do(Xᵢ=xᵢ), in which the target Xᵢ is set to a value xᵢ, for instance as, p^{I}(Xᵢ|pa(Xᵢ))=δ_{X}_{ᵢ}₌ₓ_{ᵢ}, where δ represents a Dirac delta function, which is one when the statement in subscript is true (here Xᵢ=xᵢ), and otherwise zero. On the other hand, soft interventions in which the conditional distribution changes may be modeled, for example, as p^{I}(Xᵢ|pa(Xⁱ))≠p^{obs}(Xᵢ|pa(Xᵢ)).

In temporal intervened sequences (TRIS), there is an underlying latent temporal causal process with K multidimensional causal factors, for which we can observe a temporal sequence of entangled high-dimensional observations (e.g., images), some of which may be a result of an intervention on the underlying system. For example, in the game Pong, the latent causal factors may correspond to the position of the paddle or the ball, while the observation is the image.

In this TRIS setting, identifying the underlying causal factors may be challenging. In a multidimensional setting (e.g., TRIS), interventions may only change parts of a causal factor, which makes it even more challenging to identify the underlying causal factors. Therefore, a concept of minimal causal mechanisms may be defined to represent the manipulable part of each causal factor.

In TRIS, data may be generated by an underlying latent temporal causal process with K causal factors (C₁^{t}, C₂^{t}, . . . , C_{K}^{t})ₜ₌₁^{T}, such that each Cᵢ^{t}∈ [symbol] ᵢ^{M}^{ᵢ}, where Mᵢ≥1 is the dimensionality of the causal factor Cᵢ^{t}, and [symbol] ᵢ is [symbol] (e.g., in the space of real numbers) for continuous variables (e.g., the position of the ball), [symbol] for discrete variables (e.g., the score of a player) or mixed. The causal factor space may be defined as C= [symbol] ₁^{M}^{₁}× [symbol] ₂^{M}^{₁}× . . . × [symbol] _{K}^{M}^{_{K}}.

Given an observation function h:C×ξ→X, from the causal space C and the space of the noise variables E to the observation space X, the observation space may be considered to be X⊂ [symbol] ^{N}. At each time step t, only a high-dimensional observation h(C₁^{t}, C₂^{t}, . . . , C_{K}^{t}, ∈₀^{t}) that represents an entangled view of all the causal factors, perturbed by some noise ∈₀^{t}, may be observed.

Unlike conventional approaches that work on causal representation learning, which considers causal factors to be one-dimensional, in accordance with aspects of the present disclosure, the causal factors may be multidimensional, for example such that Cᵢ∈ [symbol] ᵢ^{M}^{ᵢ} with Mᵢ≥1. As such, modeling different levels of causal variables (e.g., a two-dimensional position encoded in a single factor with two dimensions instead of two different causal factors) may be enabled. The individual Mᵢ values may be implicitly learned, given that an upper-bound of their sum is known (e.g., the dimension of the causal factor space C), which may be denoted as M.

In some aspects, the observation function h:C×ξ→X is injective, which implies that there exists a function ƒ:X→C that is a one-sided inverse, and which satisfies ƒ∘h=id_{C}, where id_{C} is the identity operator of the causal factors (ƒ(h(C,∈))=C for any causal factors C and noise ∈). That is, by first applying the function h and then applying the function ƒ on the output of h will produce the same output as just taking the C component (causal factor) of the input. Accordingly, each causal factor may be uniquely identified from observations by learning an approximation of ƒ, while disregarding irrelevant features in the observation space, such as noise, for instance.

In some aspects, the underlying latent causal process may be a dynamic Bayesian network (DBN) over the multidimensional random variables (C₁, C₂, . . . , C_{K}) that is first-order Markov, stationary, and without instantaneous effects between different variables. Thus, each causal factor Cᵢ may be instantiated at each time step t, denoted with Cᵢ^{t}, and its causal parents may be, and in some aspects, may only be, causal factors at time t=1, denoted as Cⱼ^{t-1}, including its previous value Cᵢ^{t-1}. Moreover, the structure of the graph and its parameters may be time-invariant (e.g., repeating across each pair of time steps). Furthermore, the causal factors may be causally sufficient (e.g., there are no additional latent confounders) and the distribution satisfies the causal faithfulness assumption (e.g., there are no additional independences with respect to the causal factors encoded in the graph).

In each time step t, some causal factors may have been intervened upon, and as such, the intervention targets may be accessed. These intervention targets may be denoted by the binary vector I^{t}∈{0,1}^{K} where I^{t}=1 refers to an intervention on the causal variable Cᵢ^{t}. From the graphical perspective, each component of this vector Iᵢ^{t} may be considered as a single intervention variable that causes Cᵢ^{t}.

In TRIS, it is challenging to disentangle two causal factors if they are always intervened upon jointly, or, on the contrary, if they are never intervened upon. Additionally, if two causal factors Cᵢ and Cⱼ have only been intervened on together or not at all, then there exists a causal graph in which Cᵢ and Cⱼ cannot be disentangled. Furthermore, in TRIS, it is challenging to completely reconstruct a multidimensional causal factor, if some of its components have not been intervened upon in any intervention.

In TRIS, because interventions may only change some components of a causal factor's causal mechanism, observing single-target interventions for all variables may not guarantee full identifiability. Given that for each causal factor Cᵢ, there exists a split sᵢ^{var} (Cᵢ), sᵢ^{inv}(Cᵢ) with an invertible function ƒᵢ:

$${C}_{i} = {f}_{i} ( [ {s}_{i}^{var} ( {C}_{i} ) , {s}_{i}^{inv} ( {C}_{i} ) ] ) \qquad ( 1 )$$

$${f}_{i}^{- 1} ( {C}_{i} ) = [ {s}_{i}^{var} ( {C}_{i} ) , {s}_{i}^{inv} ( {C}_{i} ) ] , \qquad ( 2 )$$

such that the conditional distribution of C given its parents, including the intervention variable Iᵢ^{t+1}, can be factored as:

$$p ( {C}_{i}^{t + 1} \vert {C}^{t} , {I}_{i}^{c + 1} ) = p ( {s}_{i}^{var} ( {C}_{i}^{t + 1} ) \vert {C}^{t} , {I}_{i}^{t + 1} ) \cdot p ( {s}_{i}^{inv} ( {C}_{i}^{t + 1} ) \vert {C}^{t} ) . \qquad ( 3 )$$

In other words, sᵢ^{var}(Cᵢ) represents the information of (Cᵢ) that can change through an intervention at any time step. In contrast, sᵢ^{inv}(Cᵢ) is the part of the variable, which is independent of the intervention. For any causal variable, there exists the trivial split sᵢ^{var}(Cᵢ^{t+1})=Cᵢ, sᵢ^{inv}(Cᵢ^{t+1})=0. However, multiple splits may exist.

It may be desirable to identify the minimal split that contains all the manipulable information in s^{var}. The minimal causal mechanism of a variable Cᵢ with respect to its intervention Iᵢ may be defined as the conditional distribution p(sᵢ^{var}(Cᵢ^{t+1})|Cₜ,Iᵢ^{t+1}) for the split sᵢ^{var} (Cᵢ), sᵢ^{inv}(Cᵢ) which maximizes the entropy of H(sᵢ^{inv}(Cᵢ)|C^{t}).

The conditional distribution p(sᵢ^{var}(Cᵢ^{t+1})|C^{t},Iᵢ^{t+1}) may be referred to as the minimal causal mechanism, because it is the smallest mechanism, which may describe the dynamics of the causal variable CL for the given interventions. Hence, the definition of this mechanism depends on the characteristics of the provided intervention. Accordingly, one goal is therefore to identify these minimal causal mechanisms in TRIS.

Consider that a dataset [symbol] of tuples {x^{t},x^{t+1},I^{t+1}} where x^{t}, x^{t+1} ∈ [symbol] ^{N} represent the observations at time step t and t+1 respectively, and I^{t+1} describes the intervention targets performed on C^{t+1}. A latent space [symbol] may be larger than the latent causal factor space C, e.g., [symbol] ⊆ [symbol] ^{M}, M≥Σᵢ₌₁^{K} Mᵢ=|C|. Because the exact dimension of the causal factor space may be unknown (e.g., because the causal factors may be multidimensional), the size of the causal factor space may be overestimated in choosing the latent space [symbol] .

An assignment function ψ: [symbol] 1 . . . M [symbol] → [symbol] 0 . . . K [symbol] , which maps each dimension of [symbol] to a causal factor, may be learned. In addition to the K causal factors, the assignment function ψ(j)=0 may indicate that the latent dimension [symbol] ⱼ does not belong to any minimal causal mechanism of the intervened causal factors. Furthermore, the pre-image of a causal factor Cᵢ may be denoted by ψᵢ=ψ⁻¹(i), for example, where ψᵢ⊂ [symbol] 1 . . . M [symbol] is the set of indices of latent variables that are assigned to the causal factor Cᵢ by ψ. This may enable the encoding of multidimensional factors, and may also benefit the optimization process, because some variables such as circular angles or categorical factors with many categories can have simpler distributions when modeled in more dimensions.

Another goal may be to learn an invertible mapping g_{θ}:X→ [symbol] , which may be combined with the learned assignment function ψ: [symbol] 1 . . . M [symbol] → [symbol] 0 . . . K [symbol] to approximate the inverse of the observation function ƒ. To implement this, a probability distribution may be modeled in the latent space, p_{ϕ}( [symbol] ^{t+1}| [symbol] ^{t},I^{t+1}) with [symbol] ₜ, [symbol] ^{t+1}∈ [symbol] being the latent variables for the observations x^{t} and x^{t+1}, respectively. The probability distribution may enforce a disentanglement over latents by conditioning each latent variable on exactly one of the intervention targets:

$${p}_{ϕ} ( {z}^{t + 1} \vert {z}^{t} , {I}^{t + 1} ) = {\prod }_{i = 0}^{K} {p}_{ϕ} ( {z}_{{ψ}_{i}}^{t + 1} \vert {z}^{t} , {I}_{i}^{t + 1} ) , \qquad ( 4 )$$

where I₀^{t+1}=Ø. Then, the objective of the model may be to maximize the likelihood p_{ϕ}(g_{θ}(x^{t+1})|g_{θ}(x^{t}),I^{t+1}) for all elements in [symbol] .

To identify causal factors (may also be referred to as “causal variables”) from high-dimensional observations over time with interventions, a variational autoencoder (VAE)-based causal representation learning architecture is provided.

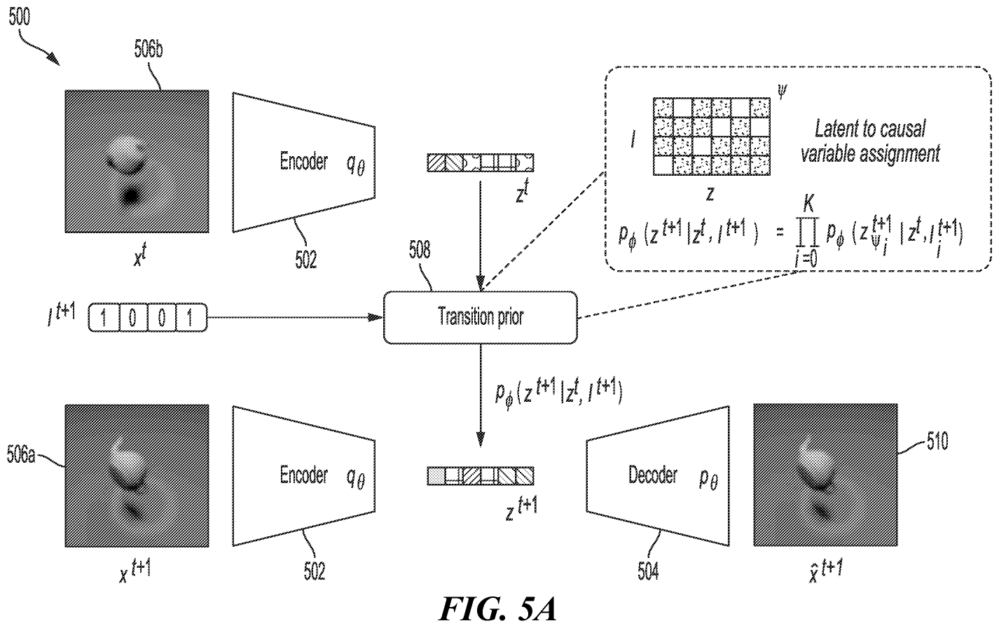

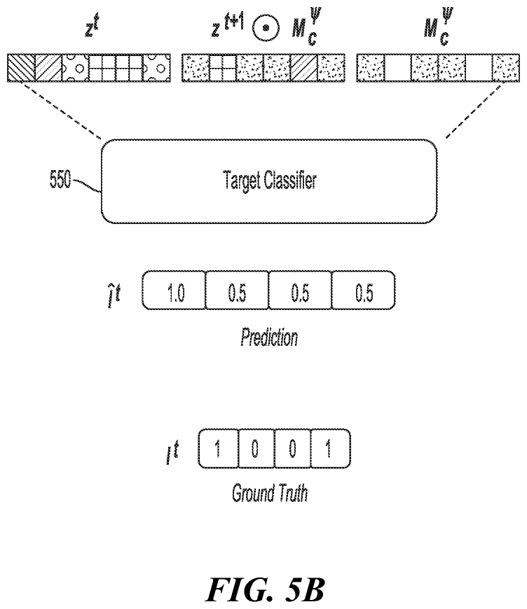

FIG. 5A is a block diagram illustrating an example architecture 500 for causal identifiability from temporal sequences with interventions, in accordance with aspects of the present disclosure. Referring to FIG. 5A, the example architecture 500 may, for example, be an autoencoder such as a variational autoencoder. A variational autoencoder may be configured to map a high-dimensional (e.g., non-linear) input such as an image, for example, to a low-dimensional vector. The architecture 500 includes an encoder 502 and a decoder 504. The encoder 502 may receive an input 506a or 506b. The input 506a or 506b may include temporal sequence data such as a frame of a video, for instance. The encoder 502 may include a set of convolutional layers (e.g., 356 shown in FIG. 3). The encoder 502 may process the input 506a or 506b to map the input to a latent space (e.g., [symbol] ^{t} or [symbol] ^{t+1}, respectively).

A transition prior 508 learns an assignment matrix of latent dimensions to causal factors based on intervention targets that are entangled with the input 506a or 506b. The intervention targets (e.g., I^{t+1}) may be a binary vector, for example. The transition prior 508 uses the latent representation [symbol] ^{t} of the prior input x^{t} and the intervention target (e.g., I^{t+1}) corresponding to the current input (e.g., x^{t+1}) to learn the assignment matrix for disentangling the causal factors. That is, the causal factors may be factorized to correlate causal factors to each of the latent dimensions.

To disentangle the causal factors, an invertible mapping g_{θ} and a conditional probability distribution p_{ϕ} over the latents (e.g., [symbol] ^{t}) via maximum likelihood may be learned. The encoder 502 and the decoder 504 may represent the invertible mapping go from observations (e.g., input 506a or 506b) to latent space, and p_{ϕ}( [symbol] ^{t+1}| [symbol] ^{t},I^{t+1}) may represent the transition prior 508 on the latent variables. In the architecture 500, the objective of the model becomes evidence lower bound (ELBO), which may be summarized as:

$${ℒ}_{ELBO} = - {𝔼}_{{z}^{t + 1}} [ log {p}_{θ} ( {x}^{t + 1} \vert {z}^{t + 1} ) ] + {𝔼}_{{z}^{t} , ψ} [ {\sum }_{i = 0}^{K} {D}_{KL} ( {q}_{θ} ( {z}_{{ψ}_{i}}^{t + 1} \vert {x}^{t + 1} ) ‖ {p}_{ϕ} ( {z}_{{ψ}_{i}}^{t + 1} \vert {z}^{t} , {I}_{i}^{t + 1} ) ) ] \qquad ( 5 )$$

where D_{KL} denotes the Kullback-Leibler divergence between two distributions. [symbol] _{z}_{^{t+1}} and [symbol] _{z}_{^{t}}_{,ψ} represent the expectations over the random variable [symbol] ^{t+1} and z^{t}, Ψ, respectively.

The Kullback-Leibler (KL) divergence uses the prior definition of Equation (4), ensuring that conditioned on the previous time step and interventions, the different blocks of latent variables are independent. Thereby, the assignment function of latent-to-causal variables, ψ, may be learned via a Gumbel-Softmax distribution per latent variable. Hence, during training, a latent-to-causal variable assignment ψ may be sampled from these distributions. On the other hand, for inference, the argmax function may be used to obtain a unique assignment. To encourage information independent of any intervention to be modeled in ψ₀, the KL divergence of ψ₀ may be multiplied by 1−λ, where λ>0 is a hyperparameter (e.g., λ=0.01).

In some aspects, as an alternative to learning ψ, an assignment ψ_{0, . . . ,K} may be predefined and sufficient latent dimensions may be allocated for each causal variable.

The prior p_{ϕ} for each set of latents [symbol] _{ψ}_{ᵢ}^{t+1} may be implemented in different forms. For example, in some aspects, an autoregressive model may be employed. For each set of latents [symbol] _{ψ}_{ᵢ}^{t+1}, the model takes [symbol] ^{t}, Iᵢ^{t+1} and [symbol] ^{t+1} as input, where [symbol] ^{t+1} is masked with a sample from Ω. From this input, the model may predict a single-mode Gaussian per latent variable. The autoregressive nature of the prior may enable complex distributions as well as an instantaneous effect over the set of latents for each causal factor, while still being independent across causal factors.

The decoder 504 may receive the latent representation [symbol] ^{t+1} of the input 506a. The decoder 504 may be symmetrically configured relative to the encoder 502. The decoder 504 may process the latent representation to generate a reconstruction 510 of the input 506a.

FIG. 5B is a block diagram illustrating a target classifier 550, which may be incorporated with the architecture 500 of FIG. 5A to support optimization, in accordance with aspects of the present disclosure. Since a causal variable Cᵢ is independent of any other target variable when conditioned on interventions Iᵢ, those independence relations may guide the disentanglement in latent space. Specifically, the target classifier 550 may be an additional small network that may be trained to predict the intervention targets from the latent variables over time, for example, modeling p(I^{t+1}| [symbol] ^{t}, [symbol] _{ψ}_{ᵢ}^{t+1}) for i∈ [symbol] 0 . . . K [symbol] . To guide the disentanglement, the gradients of the target classifier 550 with respect to [symbol] ^{t}, [symbol] ^{t+1} and ψ may be determined to make the prediction go towards one for p(I^{t+1}| [symbol] ^{t}, [symbol] _{ψ}_{ᵢ}^{t+1}). However, the intervention targets Iᵢ^{t+1} should not be fully identifiable by any other set of latents except [symbol] _{ψ}_{ᵢ}^{t+1}. This way, the target classifier 550 may ensure that information about all causal variables may be encoded in the latent space and the assignment function ψ. As shown in FIG. 5B, a mask M_{C}^{ψ} may be applied to latents (e.g., [symbol] ^{t+1}) of a current time step. The masked latent may be provided along with the latent of the prior time step as input to the target classifier 550. Using the masked latent and the latent of the prior time step, the target classifier 550 may be trained such that only latent variables that are assigned to a causal factor should be able to reconstruct whether it has been intervened on. As such, the target classifier 550 may guide the architecture 500 to encode only information from certain causal factors in certain latent dimensions.

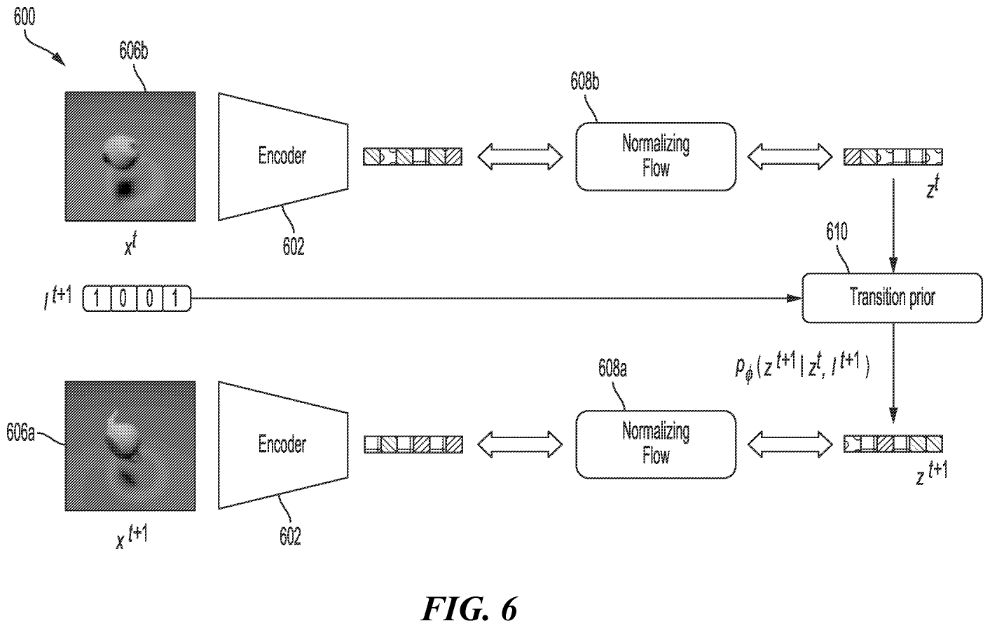

FIG. 6 is a block diagram illustrating an example architecture 600 for causal representation, in accordance with aspects of the present disclosure. The architecture 600 may be configured similar to the architecture 500 of FIG. 5A. That is, the architecture 600 may include an autoencoder including an encoder 602 that receives inputs 606a, 606b and a decoder (not shown). However, the autoencoder of architecture 600 may be a pre-trained autoencoder. Despite the improved optimization process by the addition of target classifiers, in some cases, variational autoencoders (VAEs) may still struggle to model high-dimensional complex images (e.g., where small details in the image are relevant). To overcome this issue, a pre-trained autoencoder that does not explicitly model the latent distribution may be used instead of learning the VAE. For example, in some aspects, the invertible gap g_{θ} may be implemented by a deep autoencoder, which may be trained to encode and decode the high-dimensional observations to low-dimensional feature vectors, independently of any disentanglement. During training, small Gaussian noise may be added to latents to prevent the distribution in the latent space from collapsing to single delta peaks. However, the latents may not be regularized to follow a certain prior like in a VAE, thus allowing arbitrarily complex marginal distributions.

Additionally, after the autoencoder has converged, the autoencoder parameters may be fixed resulting in a normalizing flow 608a, 608b that maps the entangled representation to a disentangled version via a learned transition prior 610. The invertibility of the normalizing flow 608a, 608b may ensure that information is not lost when mapping from the entangled to disentangled space, and thus the pre-trained decoder may reconstruct the observations without fine-tuning.

Benefits of this approach may include that the autoencoder (e.g., encoder 602) may be trained on observational data alone, while the normalizing flow 608a, 608b works on lower-dimensional data, making the whole approach more data efficient. In addition, learning a separate autoencoder may provide an opportunity for generalizing causal factors beyond the known dataset. For instance, an autoencoder (e.g., encoder 602) may be trained on two datasets, where only one has interventions, e.g., synthetic and real-world data. Then, because the autoencoder (e.g., encoder 602) uses a joint latent space for both datasets, training the normalizing flow 608a, 608b on only the dataset with interventions may lead to a disentanglement function that generalizes to a purely observational dataset. Furthermore, the setup may be easier to optimize because the autoencoder (e.g., encoder 602) can compress the information in an almost unrestricted latent space, while the normalizing flow 608a, 608b may solely focus on optimizing the likelihood in latent space, which may be the objective for disentangling the features.

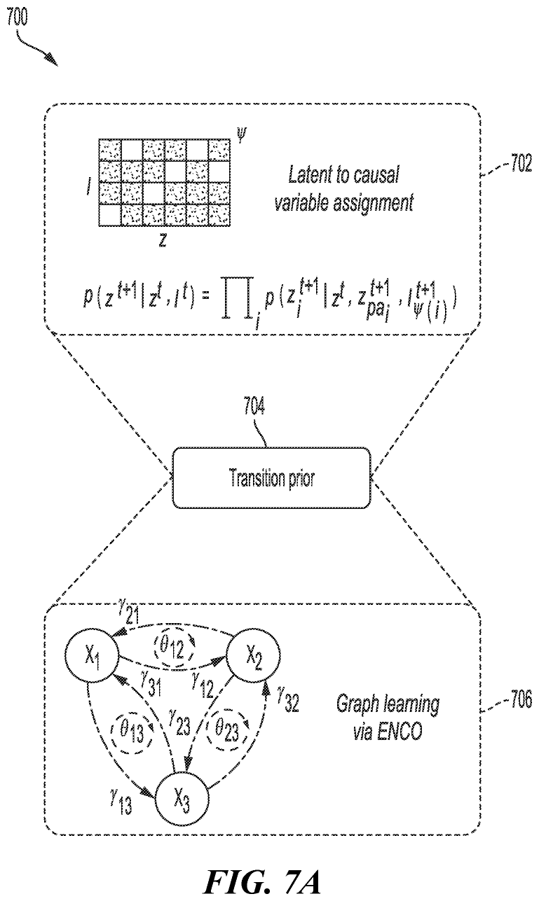

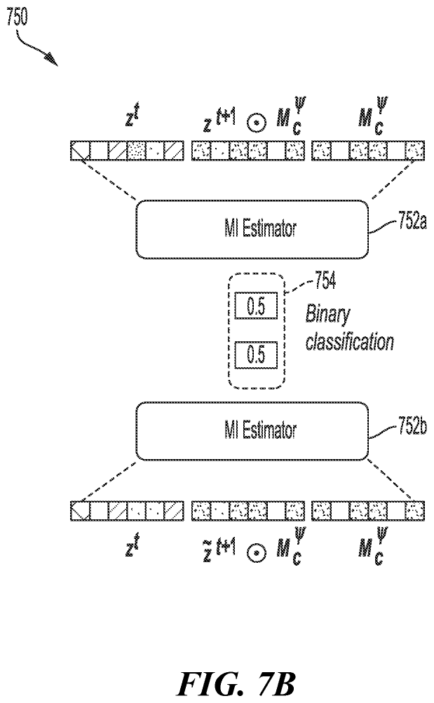

FIG. 7A is a block diagram illustrating an example process 700 for causal representation, in accordance with aspects of the present disclosure. Referring to FIG. 7A, the example process 700 at block 702 determines an assignment of a causal variable to a latent variable. At block 704, a transition prior models an autoregressive distribution over the latent variable. Then, at block 706, a causal discovery process may be applied to determine a causal graph. In some aspects, a differential causal discovery process may be applied to learn the causal graph end-to-end. Additionally, in some aspects, grouped latent variables may represent causal variables.

FIG. 7B is a block diagram illustrating an example architecture 750 for causal representation learning for instantaneous temporal effects, in accordance with aspects of the present disclosure. Referring to FIG. 7B, the architecture 750 may include mutual information (MI) estimators 752a, 752b, and a binary classifier 754.

One challenge in causal representation learning for instantaneous temporal effects is that simultaneously identifying the causal variables and their graph may lead to a chicken-and-egg situation. That is, without knowing the causal variables, it is difficult to identify a causal graph; but without knowing the causal graph, it is difficult to disentangle the causal variables. Such a situation may cause the optimization to be unstable and suffer from convergence to local minima with incorrect graphs. To stabilize the optimization process, a graph learning scheduler may be employed. In a first training iteration, the assignment of latent variables to causal variables may be uniform, such that the gradients for graph parameters may be noisy and uninformative. Thus, a learning rate scheduling may be employed for the graph learning parameters, in which the graph parameters may be fixed for the first couple of epochs. During such training iterations, the neural network model may learn to fit the latent variables to intervention targets under an arbitrary graph, thereby leading to an initial, rough assignment of the latent variables to the causal variables. Afterwards, the learning rate may be increased to gradually start the graph learning process, while continuing to disentangle the causal variables in latent space.

In addition, mutual information estimators (e.g., 752a, 752b) may enforce independencies between parents and children causal variables under interventions. In particular, under interventions on the causal variable Ct, for example, Iᵢ^{t}=1, the following independencies may be enforced: Cᵢ^{t}⊥pa^{t}(Cᵢ), pa^{t-1}(Cᵢ)|Iᵢ^{t}=1. The same independencies may be transferred to the latent space as z_{ψ}_{ᵢ}^{t}⊥z_{ψ}_{ᵢ}_{^{pa}}^{t},z^{t-1}|Iᵢ^{t}=1. To use these independencies as learning signals in a gradient-based framework, the two variables being independent correlates to the mutual information (MI) of both to be zero.

Referring to FIG. 7B, the mutual information may be estimated by finding an optimal decision boundary between samples from the joint distribution (input to 752a) and samples from the product of the marginal distributions (input to 752b). This decision boundary corresponds to a binary classifier 754. Accordingly, the loss of the binary classifier 754 may estimate the mutual information.

Implementing this framework, the neural network (e.g., architecture 750) may be trained to distinguish between samples from the joint distribution p(z_{ψ}_{ᵢ}^{t}⊥z_{ψ}_{ᵢ}_{^{pa}}^{t},z^{t-1}|Iᵢ^{t}=1) and the product of their marginals, for instance, p(z_{ψ}_{ᵢ}^{t}|Iᵢ^{t}=1)p(z_{ψ}_{ᵢ}_{^{pa}}^{t},z^{t-1}|Iᵢ^{t}=1). While the MI estimators 752a, 752b may trained to optimize its classification accuracy, the latent variables may be trained to effectively minimize the mutual information between latent variable z_{ψ}_{ᵢ}^{t} and parents of the latent variable z_{ψ}_{ᵢ}^{t}. In this way, the latent representation may be regularized to follow the independencies between a causal variable and parents of such causal variable under interventions.

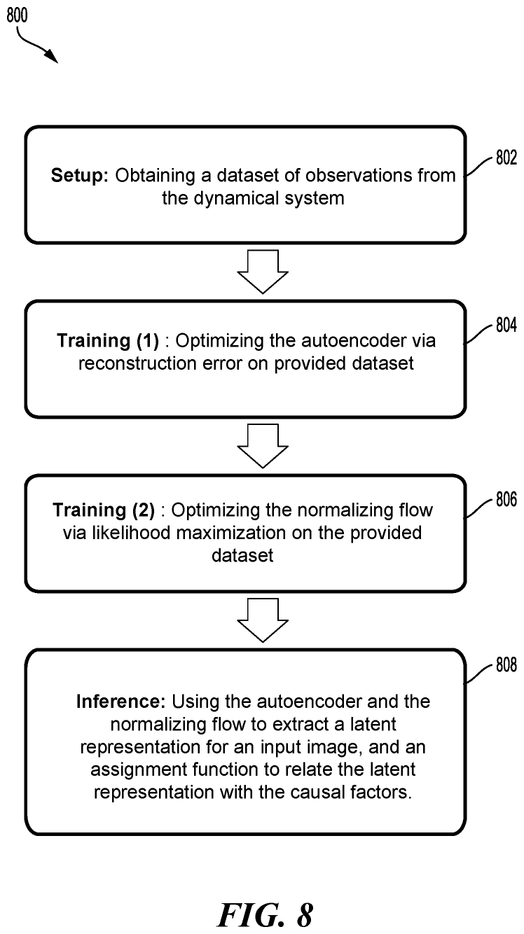

FIG. 8 is a flow diagram illustrating a process 800 for operating an example architecture for identifying causal factors from temporal sequences with interventions, in accordance with aspects of the present disclosure. As shown in FIG. 8, at block 802, the process 800 may implement a setup. A dataset of observations may be received or otherwise obtained from a dynamical system. The dataset of observations may include potential intervention targets.

At block 804, the process 800 may include architecture training. The architecture (e.g., 600 of FIG. 6) may be a pre-trained autoencoder, for example. The autoencoder may be optimized based on a reconstruction error on the provided dataset. That is, the autoencoder may receive an input via the encoder. The encoder may extract a latent representation of the input. The latent representation may be provided to the decoder. The decoder may process the latent representation to generate a reconstruction of the input. The reconstruction error may be computed based on a difference between the reconstruction and the input.

At block 806, the process 800 may train a normalizing flow. The normalizing flow may provide an invertible mapping that takes an entangled latent representation and generates a disentangled latent representation. The normalizing flow may be optimized via a likelihood maximization on the provided dataset.

At block 808, the process may use the architecture and the normalizing flow to extract a latent representation of an input image. The process may also use an assignment function to relate the latent representation with causal factors. For instance, the architecture 600 may receive an input via the encoder 602. The encoder 602 and the normalizing flow 608a, 608b may extract a latent representation or latent vector corresponding to the input. The transition priors (e.g., 610) implementing the learned assignment matrix (function) may relate the latent representation to generate an inference indicating an identification of causal factors. Furthermore, a causal graph may then be obtained using a causal discovery process.

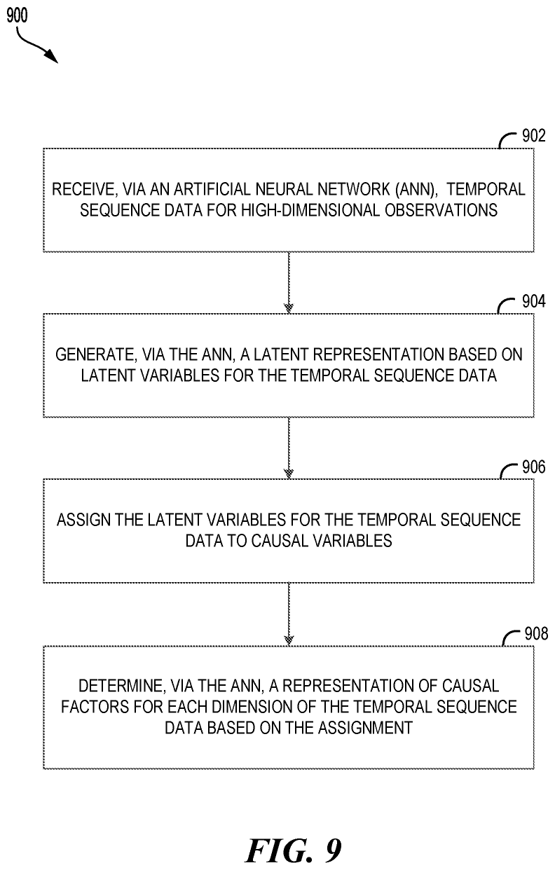

FIG. 9 is a flow diagram illustrating an example process 900 for causal representation learning for instantaneous temporal effects using an artificial neural network (ANN), in accordance with aspects of the present disclosure. At block 902, the process 900 receives, via an artificial neural network (ANN), temporal sequence data for high-dimensional observations. For example, as shown in FIG. 5A, the encoder 502 may receive an input 506a or 506b. The input 506a or 506b may include temporal sequence data such as a frame of a video, for instance.

At block 904, the process 900 generates, via the ANN, a latent representation based on latent variables for the temporal sequence data. For instance, as described with reference to FIG. 5A, the encoder 502 may process the input 506a or 506b to map the input to a latent space (e.g., [symbol] or [symbol] ^{t+1}, respectively).

At block 906, the process 900 assigns the latent variables of the temporal sequence data to causal variables. Referring to FIG. 7A, the example process 700, at block 702 determines an assignment of a causal variable to a latent variable.

At block 908, the process 900 determines, via the ANN, a representation of causal factors for each dimension of the temporal sequence data based on the assignment. Referring to FIG. 7A, at block 704, a transition prior models an autoregressive distribution over latent variable. Then, at block 706, a causal discovery process is applied to determine a causal graph.

Implementation examples are described in the following numbered clauses:

1. A processor-implemented method, comprising:
receiving, via an artificial neural network (ANN), temporal sequence data for high-dimensional observations;
generating, via the ANN, latent representation based on latent variables for the temporal sequence data;
assigning the latent variables of the temporal sequence data to causal variables; and
determining, via the ANN, a representation of causal factors for each dimension of the temporal sequence data based on the assignment.

2. The processor-implemented method of clause 1, further comprising generating a causal graph based on the causal factors via a causal discovery process.

3. The processor-implemented method of clause 1 or 2, in which a causal graph is generated concurrently with determining the representation of the causal factors.

4. The processor-implemented method of any of clauses 1-3, further comprising regularizing the latent representation based on the latent variables to follow independencies between a causal variable and a causal parent of the causal variable under interventions.

5. The processor-implemented method of any of clauses 1-4, in which the latent variables are generated based on a normalizing flow providing an invertible mapping for disentangling the causal factors.

6. The processor-implemented method of any of clauses 1-5, in which the causal factors are multidimensional.

7. The processor-implemented method of any of clauses 1-6, in which the temporal sequence data comprises a video.

8. An apparatus, comprising:
a memory; and
at least one processor coupled to the memory, the at least one processor configured:
to receive, via an artificial neural network (ANN), temporal sequence data for high-dimensional observations;
to generate, via the ANN, latent representation based on latent variables for the temporal sequence data;
to assign the latent variables of the temporal sequence data to causal variables; and
to determine, via the ANN, a representation of causal factors for each dimension of the temporal sequence data based on the assignment.

9. The apparatus of clause 8, in which the at least one processor is further configured to generate a causal graph based on the causal factors via a causal discovery process.

10. The apparatus of clause 8 or 9, in which the at least one processor is further configured to generate a causal graph concurrently with determining the representation of the causal factors.

11. The apparatus of any of clauses 8-10, in which the at least one processor is further configured to regularize the latent representation based on the latent variables to follow independencies between a causal variable and a causal parent of the causal variable under interventions.

12. The apparatus of any of clauses 8-11, in which the at least one processor is further configured to generate the latent variables based on a normalizing flow providing an invertible mapping for disentangling the causal factors.

13. The apparatus of any of clauses 8-12, in which the causal factors are multidimensional.

14. The apparatus of any of clauses 8-13, in which the temporal sequence data comprises a video.

15. A non-transitory computer-readable medium having program code recorded thereon, the program code executed by a processor and comprising:
program code to receive, via an artificial neural network (ANN), temporal sequence data for high-dimensional observations;
program code to generate, via the ANN, latent representation based on latent variables for the temporal sequence data;
program code to assign the latent variables of the temporal sequence data to causal variables; and
program code to determine, via the ANN, a representation of causal factors for each dimension of the temporal sequence data based on the assignment.

16. The non-transitory computer-readable medium of clause 15, in which the program code further comprises program code to generate a causal graph based on the causal factors via a causal discovery process.

17. The non-transitory computer-readable medium of clause 15 or 16, in which the program code further comprises program code to generate a causal graph concurrently with determining the representation of the causal factors.

18. The non-transitory computer-readable medium of any of clauses 15-17, in which the program code further comprises program code to regularize the latent representation based on the latent variables to follow independencies between a causal variable and a causal parent of the causal variable under interventions.

19. The non-transitory computer-readable medium of any of clauses 15-18, in which the program code further comprises program code to generate the latent variables based on a normalizing flow providing an invertible mapping for disentangling the causal factors.

20. The non-transitory computer-readable medium of any of clauses 15-19, in which the causal factors are multidimensional.

21. The non-transitory computer-readable medium of any of clauses 15-20, in which the temporal sequence data comprises a video.

22. An apparatus, comprising:
means for receiving, via an artificial neural network (ANN), temporal sequence data for high-dimensional observations;
means for generating, via the ANN, latent representation based on latent variables for the temporal sequence data;
means for assigning the latent variables of the temporal sequence data to causal variables; and
means for determining, via the ANN, a representation of causal factors for each dimension of the temporal sequence data based on the assignment.

23. The apparatus of clause 22, further comprising means for generating a causal graph based on the causal factors via a causal discovery process.

24. The apparatus of clause 22 or 23, further comprising means for generating a causal graph concurrently with determining the representation of the causal factors.

25. The apparatus of any of clauses 22-24, further comprising means for regularizing the latent representation based on the latent variables to follow independencies between a causal variable and a causal parent of the causal variable under interventions.

26. The apparatus of any of clauses 22-25, further comprising means for generating the latent variables based on a normalizing flow providing an invertible mapping for disentangling the causal factors.

27. The apparatus of any of clauses 22-26, in which the causal factors are multidimensional.

28. The apparatus of any of clauses 22-27, in which the temporal sequence data comprises a video.

In one aspect, the receiving means, generating means, assigning means, determining means, means for generating a causal graph and/or regularizing means may be the GPU 104, program memory associated with the GPU 104, fully connected layers 362, NPU 428 and or the routing connection processing unit 216 configured to perform the functions recited. In another configuration, the aforementioned means may be any module or any apparatus configured to perform the functions recited by the aforementioned means.

The various operations of computer-implemented methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (TR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A processor-implemented method, comprising:
receiving, via an artificial neural network (ANN), temporal sequence data for high-dimensional observations;
generating, via the ANN, latent representation based on latent variables for the temporal sequence data;
assigning the latent variables of the temporal sequence data to causal variables; and
determining, via the ANN, a representation of causal factors for each dimension of the temporal sequence data based on the assignment.

2. The processor-implemented method of claim 1, further comprising generating a causal graph based on the causal factors via a causal discovery process.

3. The processor-implemented method of claim 1, in which a causal graph is generated concurrently with determining the representation of the causal factors.

4. The processor-implemented method of claim 1, further comprising regularizing the latent representation based on the latent variables to follow independencies between a causal variable and a causal parent of the causal variable under interventions.

5. The processor-implemented method of claim 1, in which the latent variables are generated based on a normalizing flow providing an invertible mapping for disentangling the causal factors.

6. The processor-implemented method of claim 1, in which the causal factors are multidimensional.

7. The processor-implemented method of claim 1, in which the temporal sequence data comprises a video.

8. An apparatus, comprising:
a memory; and
at least one processor coupled to the memory, the at least one processor configured:
to receive, via an artificial neural network (ANN), temporal sequence data for high-dimensional observations;
to generate, via the ANN, latent representation based on latent variables for the temporal sequence data;
to assign the latent variables of the temporal sequence data to causal variables; and
to determine, via the ANN, a representation of causal factors for each dimension of the temporal sequence data based on the assignment.

9. The apparatus of claim 8, in which the at least one processor is further configured to generate a causal graph based on the causal factors via a causal discovery process.

10. The apparatus of claim 8, in which the at least one processor is further configured to generate a causal graph concurrently with determining the representation of the causal factors.

11. The apparatus of claim 8, in which the at least one processor is further configured to regularize the latent representation based on the latent variables to follow independencies between a causal variable and a causal parent of the causal variable under interventions.

12. The apparatus of claim 8, in which the at least one processor is further configured to generate the latent variables based on a normalizing flow providing an invertible mapping for disentangling the causal factors.

13. The apparatus of claim 8, in which the causal factors are multidimensional.

14. The apparatus of claim 8, in which the temporal sequence data comprises a video.

15. A non-transitory computer-readable medium having program code recorded thereon, the program code executed by a processor and comprising:
program code to receive, via an artificial neural network (ANN), temporal sequence data for high-dimensional observations;
program code to generate, via the ANN, latent representation based on latent variables for the temporal sequence data;
program code to assign the latent variables of the temporal sequence data to causal variables; and
program code to determine, via the ANN, a representation of causal factors for each dimension of the temporal sequence data based on the assignment.

16. The non-transitory computer-readable medium of claim 15, in which the program code further comprises program code to generate a causal graph based on the causal factors via a causal discovery process.

17. The non-transitory computer-readable medium of claim 15, in which the program code further comprises program code to generate a causal graph concurrently with determining the representation of the causal factors.

18. The non-transitory computer-readable medium of claim 15, in which the program code further comprises program code to regularize the latent representation based on the latent variables to follow independencies between a causal variable and a causal parent of the causal variable under interventions.

19. The non-transitory computer-readable medium of claim 15, in which the program code further comprises program code to generate the latent variables based on a normalizing flow providing an invertible mapping for disentangling the causal factors.

20. The non-transitory computer-readable medium of claim 15, in which the causal factors are multidimensional.

21. The non-transitory computer-readable medium of claim 15, in which the temporal sequence data comprises a video.

22. An apparatus, comprising:
means for receiving, via an artificial neural network (ANN), temporal sequence data for high-dimensional observations;
means for generating, via the ANN, latent representation based on latent variables for the temporal sequence data;
means for assigning the latent variables of the temporal sequence data to causal variables; and
means for determining, via the ANN, a representation of causal factors for each dimension of the temporal sequence data based on the assignment.

23. The apparatus of claim 22, further comprising means for generating a causal graph based on the causal factors via a causal discovery process.

24. The apparatus of claim 22, further comprising means for generating a causal graph concurrently with determining the representation of the causal factors.

25. The apparatus of claim 22, further comprising means for regularizing the latent representation based on the latent variables to follow independencies between a causal variable and a causal parent of the causal variable under interventions.

26. The apparatus of claim 22, further comprising means for generating the latent variables based on a normalizing flow providing an invertible mapping for disentangling the causal factors.

27. The apparatus of claim 22, in which the causal factors are multidimensional.

28. The apparatus of claim 22, in which the temporal sequence data comprises a video.
